(19) United States
(12) Patent Application Publication
(10) Pub. No.: US 2018/0184378 A1
(43) Pub. Date: Jun. 28, 2018

(54) WIRELESS COMMUNICATION DEVICE, SYSTEM AND METHOD TO GENERATE AN ENHANCED ORTHOGONAL FREQUENCY DIVISION MULTIPLE ACCESS PACKET WITH BOTH AN OFDMA SIGNAL AND A LOW-POWER WAKE-UP SIGNAL

(71) Applicant: Intel Corporation, Santa Clara, CA (US)

(72) Inventors: Juan Fang, Portland, OR (US); Shahrnaz Azizi, Cupertino, CA (US); Minyoung Park, Portland, OR (US); Thomas J. Kenney, Portland, OR (US)

(73) Assignee: Intel Corporation, Santa Clara, CA (US)

(21) Appl. No.: 15/391,381

(22) Filed: Dec. 27, 2016

(51) Int. Cl. H04W 52/02; H04L 5/00

(52) U.S. Cl. CPC H04W 52/0235; H04W 84/12; H04L 5/0007

(57) ABSTRACT

A wireless communication device, system and method. The device includes a memory and processing circuitry coupled to the memory. The processing circuitry has a main baseband processor and a low power baseband processor, and further includes logic to cause the low-power baseband processor to process an orthogonal frequency division multiple access (OFDMA) signal allocated to a predetermined resource unit (RU) of an OFDMA packet as an OOK modulated signal including a sequence of bit values of 1 and 0. The sequence represents a low-power wake up (LP-WU) packet. The OFDMA packet has a plurality of RUs and is addressed to one or more destination OFDMA devices. The low power baseband processor is to decode an OFDMA symbol allocated to the predetermined RU as a bit value of 1, and to decode an absence of an OFDMA symbol from the predetermined RU as a bit value of 0. The logic is further to cause a wake-up of the main baseband processor based on the LP-WU packet. The main baseband processor may process subsequent OFDMA modulated data symbols as OFDMA modulated data symbols after waking up

### TECHNICAL FIELD

Embodiments relate to wireless communication in a low power setting. Some demonstrative embodiments relate to a construction of low-power wake-up (LP-WU) packet or pulse for waking up a wireless local-area network (WLAN) device with low-power wake-up receiver (LP-WUR) within an IEEE 802.11ax network.

### BACKGROUND

Low power wireless devices are enabling many wireless devices to be deployed in wireless local-area network (WLAN). However, the low power wireless devices are bandwidth constrained and power constrained, and yet need to communicate with central devices to download and upload data. Additionally, wireless devices may need to operate with both newer protocols and with legacy station protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some demonstrative embodiments;

FIG. 2 illustrates a radio architecture of a STA or an AP from the ESS of FIG. 1 in accordance with some demonstrative embodiments;

FIG. 3a illustrates a High Efficiency (HE) Orthogonal Frequency Division Multiple Access (OFDMA) physical layer convergence procedure (PLCP) protocol data unit (PPDU) structure for a 20 MHz communication as defined in 802.11ax;

FIG. 3b illustrates a LP-WU packet overlaid onto an OFDMA signal in the time domain according to some demonstrative embodiments;

FIG. 4 illustrates a configuration of the overlaid signal showing an exemplary sequence of bit values of 1 and 0 that define a LP-WU packet according to some demonstrative embodiments'

FIG. 5 illustrates a LP-WU packet plus legacy 802.11 preamble in the time domain in accordance with some demonstrative embodiments;

FIG. 6 illustrates a product of manufacture in accordance with some demonstrative embodiments; and

FIG. 7 illustrates a flow-chart of a method according to some demonstrative embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some demonstrative embodiments may be included in, or substituted for, those of other embodiments. Embodiments set forth in the claims encompass all available equivalents of those claims.

To reduce power consumption in a BSS, the idea of using a low-power wake-up receiver in Wi-Fi devices was developed, and was introduced into the IEEE 802.11 community in late 2015. Since that time, LP-WUR has received much attention. Recently, a new Study Group (SG) named Wake-Up Receiver (WUR) SG was formed under IEEE 802.11 to study and begin standardization of the new wireless communication protocol as a new amendment to the 802.11 standard specification. The WUR provide a low power solution (for example about 100 μW in an active state) for always on Wi-Fi or Bluetooth (BT connectivity) of wearable, IoT or other emerging devices that may be densely deployed. Hereinafter, LP-WUR may be used to refer to the 802.11 LP-WUR wireless communication protocol, or to a LP-WU receiver (that is, receiver circuitry providing LP-WU functionality) that is compliant with such protocol, and the meaning of the acronym will be clear from the context within which it is used.

Although, the design of WUR introduced to the 802.11 community is based on the legacy 802.11a/g/n/ac 4 pec OFDM symbol duration, an 802.11ax compatible OFDMA based design is an ongoing study item internally.

The concept of transmitting a Low-Power Wake-Up (LP-WU) packet in an 802.11ax OFDMA sub-channel and the construction of wake-up (WU) pulse which is compatible with 802.11ax OFDMA structure are currently being developed. For the case of OFDMA based WUR designs, in order to provide orthogonality to the OFDMA packet, the wake-up pulse may be constructed with one OFDMA symbol duration. An OFDMA symbol duration in 802.11ax is 4× the size of the symbol duration in 802.11a/g/n/ac. To design a LP-WU packet within resource unit (RU) allocations of an 802.11ax OFDMA signal, the impact of the inter-OFDMA adjacent channel interference into WUR performance may be considered. To reduce the impact of adjacent RU interference on the LP-WUR, one option may be to design the signal such that a LP-WU signal is allocated to one RU of the signal, and further such that some RUs adjacent to the RU to which LP-WU signals are allocated are nulled in order to function as guard bands. However, leaving RUs as guard bands may reduce the overall spectrum efficiency as more time-frequency resources may be wasted, and this is especially true in cases where the LP-WU-pulse/symbol is constructed with long symbol duration.

In order to increase spectrum efficiency by avoiding reserving many RUs as guard RUs, some demonstrative embodiments herein propose to enable an overlaying of an OFDMA signal including OFDMA modulated data symbols with an On-Off Keying (OOK) modulated WU signal including LP-WU symbols. The above may be achieved by allocating the OFDMA signal within a predetermined RU of an OFDMA packet addressed to one or more destination 802.11ax wireless communication device(s), and my modulating the OFDMA signal as an OOK modulated signal to thus modulate the bit sequence of an LP-WU packet addressed to an intended receiver of the LP-WU packet. The intended receiver (such as, for example, a low power baseband processor) may be different from the 802.11ax wireless communication devices to which the data in the OFDMA signal is being addressed (hereinafter destination OFDMA devices). Some demonstrative embodiments include designing a destination OFDMA device such that it is able to determine, by processing/demodulating a preamble of the OFDMA packet being sent, whether an OFDMA signal addressed to it has been overlaid with an OOK modulated WU signal. In such a case, the destination OFDMA device may know to perform envelope detection on the OFDMA signal to determine the OOK sequence, and to use this sequence to demodulate the OFDMA data in the OFDMA signal.

As previously noted, it is possible to send an LP-WU signal in a predetermined RU, such as the central RU of an OFDMA signal, without overlaying the same onto the OFDMA signal. In such cases, it would be beneficial to null the RUs adjacent to the RU carrying the LP-WU signal in order to reduce packet error rates through inter-RU interference. However, nulling adjacent RUs as noted above may reduce system efficiency. In contrast, demonstrative embodiments, by using 802.11 OFDMA signals as OOK transmit signals to modulate the bit sequence of a LP-WU packet, enable a transmitter to transmit a LP-WU packet to its intended receiver to wake up the main baseband processor (for example, an 802.11 baseband processor) of the receiver, and at the same to enable the transmitter to transmit actual user data to destination OFDMA devices (such as destination OFDMA baseband processors) simultaneously. Demonstrative embodiments therefore enable efficient use of time-frequency resources. Embodiments minimize power consumption and latency of a Wi-Fi radio with minimum spectral efficiency loss and with very low interference from LP-WU signal to -OFDMA signals. The LP-WU payload may be efficiently used by the intended receiver, such as a LP-WU receiver, to wake-up a main baseband processor such that the main baseband processor can emerge from its doze or sleep state, and be ready to modulate or demodulate OFDMA modulated data packets. It is within the scope of demonstrative embodiments to have the main baseband processor be a baseband processor other than a Wi-Fi baseband processor. For example, it could be a Bluetooth baseband processor. In such a case, embodiments envision modulating a wireless signal according to a first wireless communication protocol, such as, for example, a BT signal, such that a LP-WU signal if overlaid onto the BT signal to generate an OOK modulated symbol.

Demonstrative embodiments contemplate the provision of a new OFDMA packet in which an LP-WU symbol is overlaid onto an OFDMA symbol. By way of example, a LP-WU packet may be used to modulate the OFDMA signal allocated to a predetermined RU in which the LP-WU packet is transmitted. This new frame format may be signaled to 802.11ax receivers that support a LP-WU packet regime according to demonstrative embodiments, for example, this signaling may be achieved through defining a reserve bit in HE-SIG fields of the preamble.

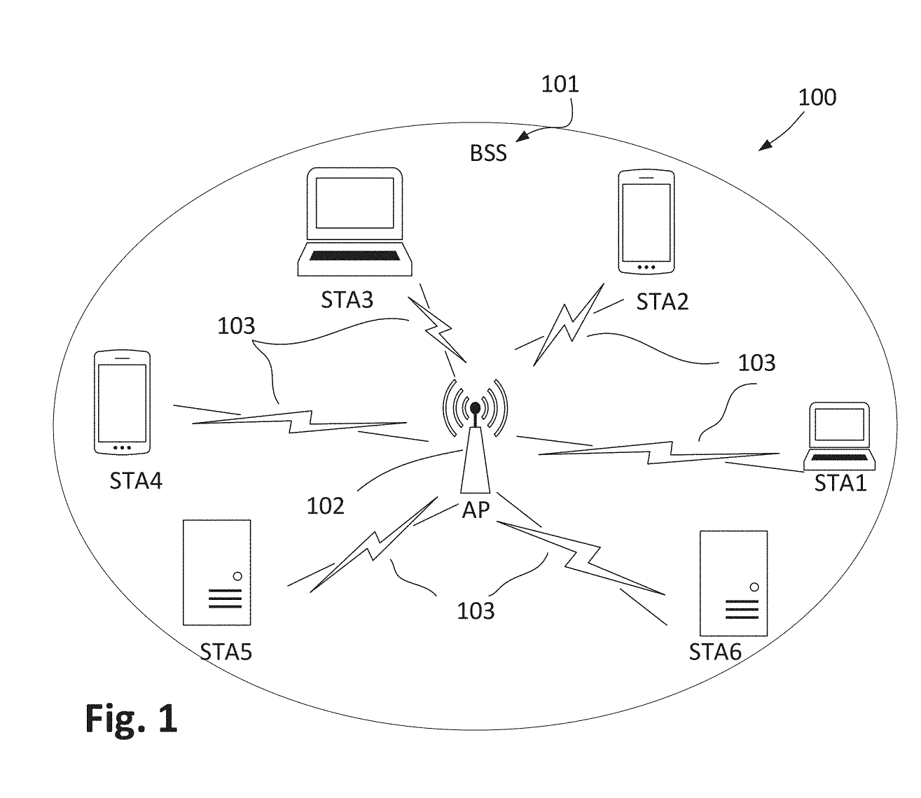

Referring now to FIG. 1, a Wireless Local Area Network (WLAN) 100 is illustrated in accordance with some demonstrative embodiments. This is an example of a WLAN which may include devices that may be configured to transmit or receive LP-WU signals multiplexed into a Wi-Fi signals according to some demonstrative embodiments. The WLAN may comprise a Basic Service Set (BSS) 101 that may include an access point (AP), a plurality of HE Wi-Fi (HEW) (e.g., referring to the Institute of Electrical and Electronics Engineers (IEEE) 802.11ax standard) stations (STAs) STA1 and STA2, a plurality of legacy (e.g., IEEE 802.11a/b/g/n/ac) devices STA3 and STA4, and a plurality of IoT devices STA5 and STA6 (e.g., IEEE 802.11ax)

The AP may use one of the IEEE 802.11 wireless communication protocols to transmit and receive. The AP may further include a base station. The AP may use other communications protocols as well as any of the IEEE 802.11 protocols. The IEEE 802.11 protocols may include the IEEE 802.11ax protocol. The IEEE 802.11 protocols may include using orthogonal frequency division multiple-access (OFDMA), time division multiple access (TDMA), and/or code division multiple access (CDMA). The IEEE 802.11 protocols may include a multiple access technique. For example, the IEEE 802.11 protocol may include space-division multiple access (SDMA) and/or multiple-user multiple-input multiple-output (MU-MIMO).

The legacy stations STA3 and STA4 may operate in accordance with legacy wireless communication protocols, such as one or more of IEEE 802.1111a/b/g/n/ac, and/or another legacy wireless communication protocols. The HEW STAs STA1 and STA2 may include wireless transmit and receive devices such as cellular telephones, smart telephones, handheld wireless devices, wireless glasses, wireless watches, wireless personal devices, tablets, or other devices that may be transmitting and receiving using the any of the IEEE 802.11 protocols such as IEEE 802.11ax or another wireless communication protocol. In some demonstrative embodiments, the HEW STAs STA1 and STA2 may be termed high efficiency (HE) stations. The AP may communicate with legacy stations STA3 and STA4 in accordance with legacy IEEE 802.11 communication protocols. In example embodiments, the AP may also be configured to communicate with HEW STAs STA1 and STA2 in accordance with legacy IEEE 802.11 communication techniques.

The IoT devices STA5 and STA6 may operate in accordance with IEEE 802.11ax or another wireless communication protocol of 802.11. The IoT devices STA5 and STA6 may operate on a smaller sub-channel than the HEW stations STA 1 and STA2. For example, the IoT devices STA5 and STA6 may operate on 2.03 MHz or 4.06 MHz sub-channels. In some demonstrative embodiments, the IoT devices STA5 and STA6 may not be able to transmit or receive on a 20 MHz sub-channel to or from the AP with sufficient power due to battery constraints. The IoT devices STA5 and STA6 may be sensors designed to measure one or more specific parameters of interest such as temperature sensor, humidity, or location-specific sensors. IoT devices STA5 and STA6 may be connected to a sensor hub (not illustrated), and may upload data to the sensor hub. The sensor hub may upload the data to an access gateway (not illustrated) that may connect several sensor hubs to a cloud sever. The AP may act as the access gateway in accordance with some demonstrative embodiments. The AP may act as the sensor hub in accordance with some demonstrative embodiments. In some other demonstrative embodiments, the IoT devices STA5 and STA6 may need to consume very low average power in order to perform a packet exchange with the AP.

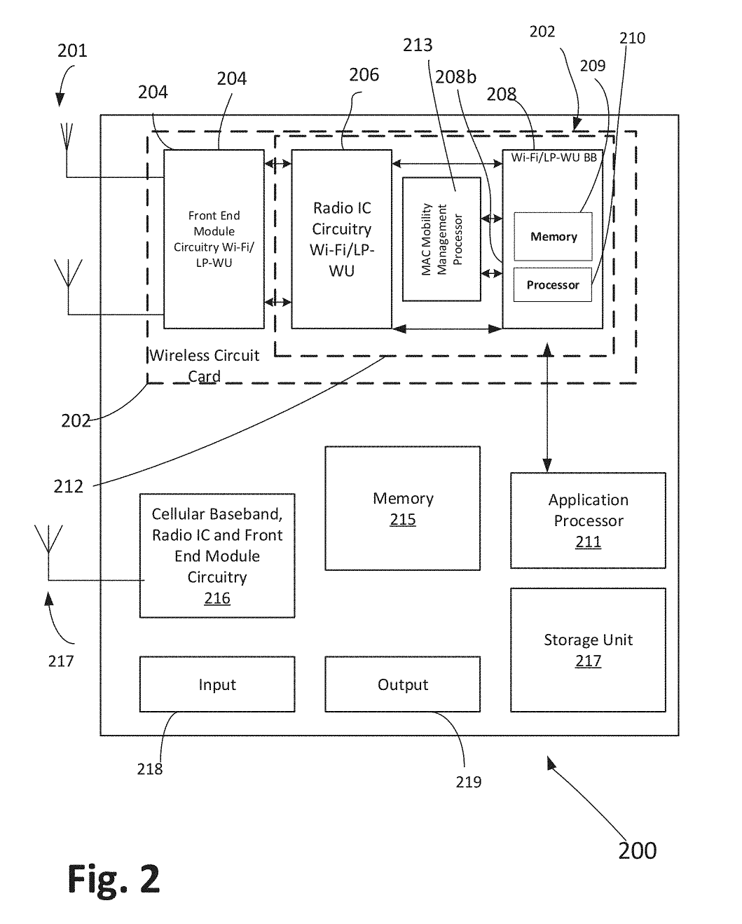

In some demonstrative embodiments, the AP may be adapted to send low-power wake-up (LP-WU) packets to the HEW stations STA1 and STA2, and/or IoT devices STA5 and STA6 that may be adapted to receive and decode packets configured according to an IEEE Low-Power Wake-Up Receiver (LP-WUR) wireless communication protocol. Communication compliant with the LP-WUR wireless communication protocol may be made possible through the use of a low-power wake-up receiver, e.g., one that uses 100 μW in a listen state, as will be described further below in relation to FIG. 2. LP-WUR compliant stations within the BSS of FIG. 1 that have entered a power save mode may exit the power save when they receive and decode a LP-WU signal.

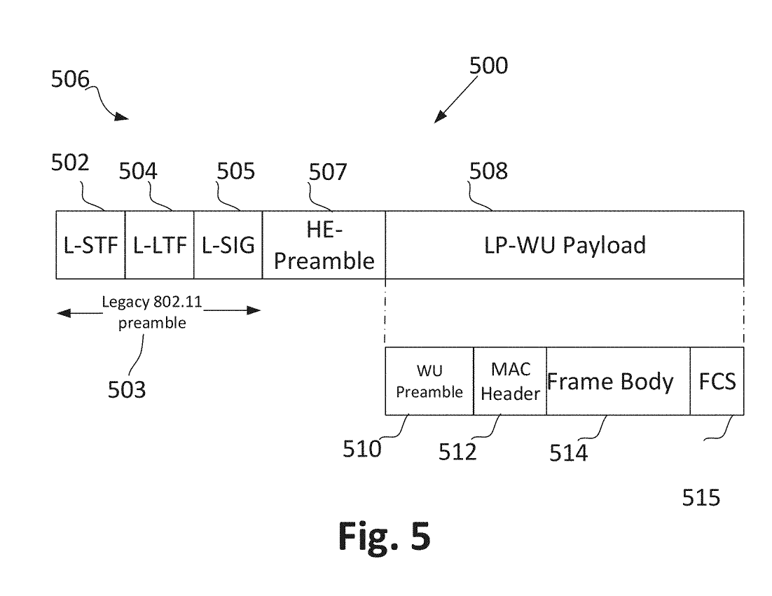

In some demonstrative embodiments, the AP, HEW stations STA1 and STA2, legacy stations STA3 and STA4, and/or IoT devices STA5 and STA6 may enter a power save mode and exit the power save mode periodically or at pre-scheduled times to see if there is a packet for them to be received. Those stations that are LP-WUR compliant may enter a power save mode and remain in the power save mode at least until they receive a LP-WU packet from another station within the BSS. The power save mode may be a deep power save mode. A LP-WUR of a station may remain in a listen mode to receive a LP-WU packet or payload 508, which will be described in further detail in FIG. 5. The LP-WU packet may include information on an identifier/address of the station including the LP-WUR, such that the receiving station may exit its low power state when the low-power wake-up packet includes its identifier.

In some demonstrative embodiments, a HEW signal may be communicated on a subchannel that may have a bandwidth of 20 MHz, 40 MHz, or 80 MHz, 160 MHz, or 320 MHz contiguous bandwidths or an 80+80 MHz (160 MHz) non-contiguous bandwidth. In some demonstrative embodiments, the bandwidth of a HEW subchannel may be 2.03125 MHz, 4.0625 MHz, 8.28125 MHz, a combination thereof, or another bandwidth that is less or equal to the available bandwidth may also be used. The subchannel may include a number of tones, such as 26, and these tones may include a combination of data tones and other tones. The other tones may include DC nulls, guard intervals, or may be used for any purpose other than carrying data.

A HEW packet may be configured for transmitting a number of spatial streams, which may be in accordance with MU-MIMO. In other embodiments, the AP, HEW STAs STA1 and STA2, and/or legacy stations STA3 and STA4 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, or other technologies.

Some demonstrative embodiments relate to HEW communications. In accordance with some IEEE 802.11ax embodiments, an AP may be configured to contend for a wireless medium (e.g., during a contention period) to receive exclusive control of the medium for an HEW control period. In some demonstrative embodiments, the HEW control period may be termed a transmission opportunity (TXOP). The AP may transmit a HEW master-sync transmission, which may be a trigger packet or HEW control and schedule transmission, at the beginning of the HEW control period. The AP may transmit a time duration of the TXOP and sub-channel information. During the HEW control period, HEW STAs STA1 and STA2 may communicate with the AP in accordance with a non-contention based multiple access technique such as OFDMA and/or MU-MIMO.

The above is unlike conventional Wi-Fi communications in which devices communicate in accordance with a contention-based communication technique, rather than a multiple access technique. During the HEW control period, the AP may transmit a LP-WU packet to one of the stations with LP-WUR functionality. During the HEW control period, a LP-WUR included in a STA, such as in any one of the STAs of FIG. 1, may operate on a sub-channel smaller than the operating range of the AP. During a HEW control period, legacy stations refrain from communicating.

In accordance with some demonstrative embodiments, during a master-sync transmission, the LP-WUR may receive a LP-WU packet and then may wake up the HEW STAs STA1 and STA2 or IoT STAs STA5 and STAG, which then may contend for the wireless medium with the legacy stations STAs STA3 and STA4 being excluded from contending for the wireless medium during the master-sync transmission. In some demonstrative embodiments, HEW STAs STA1 and STA2 or IoT STAs 108 may communicate with the AP in accordance with a non-contention based access technique after being woken up and obtaining the UL transmit configuration from a trigger packet which may indicate an uplink (UL) UL-MU-MIMO and/or UL OFDMA control period.

In some demonstrative embodiments, the multiple-access technique used during the HEW control period may be a scheduled OFDMA technique, although this is not a requirement. In some demonstrative embodiments, the multiple access technique may be a time-division multiple access (TDMA) technique or a frequency division multiple access (FDMA) technique. In some demonstrative embodiments, the multiple access technique may be a space-division multiple access (SDMA) technique.

The AP may also communicate with legacy stations STAs STA3 and STA4 and/or HEW stations STA1 and STA2 in accordance with legacy IEEE 802.11 communication techniques. In some demonstrative embodiments, the AP may also be configurable to transmit a LP-WU packet to a LP-WUR outside the HEW control period in accordance with legacy IEEE 802.11 communication techniques, although this is not a requirement.

Reference will now be made to FIG. 2. FIG. 2 depicts one embodiment of a STA, or one embodiment of an AP, such as the AP, or HEW or IoT STAs shown in FIG. 1, as would be recognized by a skilled person, although embodiments are not so limited. At certain points within the below description, FIG. 2 will be referred to as an apparatus including an architecture for a STA 200, while at certain other points within the below description, FIG. 2 will be referred to as an apparatus including an architecture for an AP 200. The context will however be clear based on the description being provided.

Referring next to FIG. 2, a block diagram is shown of a wireless communication system such as STA 200 or AP 200 (hereinafter STA/AP 200) such as any of STA1, STA2, STA5 or STAG, or the AP of FIG. 1, according to some demonstrative embodiments. A wireless communication apparatus may include a wireless communication radio architecture 201 in accordance with some demonstrative embodiments. Radio architecture 201 may include radio front-end module (FEM) circuitry 204, radio IC circuitry 206 and baseband processor 208. Radio architecture 201 as shown includes both Wi-Fi functionality and LP-WUR functionality, although embodiments are not so limited. LP-WUR/LP-WU may refer to Medium Access Control Layer and Physical Layer specifications in accordance with efforts within the Institute of Electrical and Electronics Engineers (JEEP's regarding a LP-WUR standard.

In FIG. 2, it is to be noted that the representation of a single antenna may be interpreted to mean one or more antennas. Although FIG. 2 shows a single radio IC circuitry block 206, a single FEM circuitry block 204 and a single baseband circuitry block 208, where each of the above blocks could include both Wi-Fi and LP-WU functionality, these blocks are to be viewed as representing the possibility of one or more circuitry blocks, where potentially one set of distinct circuitry blocks, for example, a distinct FEM circuitry, a distinct radio IC circuitry, and/or a distinct LP-WU baseband circuitry would work to provide the noted LP-WU functionality. In the alternative, such functionality could be integrated either in part or in whole within the Wi-Fi circuitry. In the alternative, components providing LP-WU functionality could be provided, according to some demonstrative embodiments, within circuitry blocks positioned off of the IC 212 or wireless radio card 202, for example adjacent the application processor 211. Also, as used herein, “processing circuitry” or “processor” may include one or more distinctly identifiable processor blocks.

FEM circuitry 204 may include both Wi-Fi functionality (which would allow the processing of Wi-Fi signals) and LP-WU functionality (which would allow the processing of LP-WU signals). The FEM circuitry 204 may include a receive signal path comprising circuitry configured to operate on Wi-Fi and LP-WU RF signals received from one or more antennas 201, to amplify the received signals and to provide the amplified versions of the received signals to the radio IC circuitry 206 for further processing. FEM circuitry 204 may also include a transmit signal path which may include circuitry configured to amplify signals provided by the radio IC circuitry 206 for wireless transmission by one or more of the antennas 201. The antennas may include directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Radio IC circuitry 206 may include both Wi-Fi and LP-WU functionality, and may include therein a distinct LP-WU radio to process an LP-WU only portion of a signal that includes a LP-WU signal multiplexed into a Wi-Fi signal. Radio IC circuitry 206 as shown may include a receive signal path which may include circuitry to down-convert signals received from the FEM circuitry 204 and provide baseband signals to baseband processor 208. The radio IC circuitry 206 may also include a transmit signal path which may include circuitry to up-convert baseband signals provided by the baseband processor 208 and provide RF output signals to the FEM circuitry 204 for subsequent wireless transmission by the one or more antennas 201. In addition, embodiments include within their scope the provision of a radio IC circuitry that allows transmission of LP-WU signals.

Baseband processing circuity 208 may include processing circuitry that provides Wi-Fi functionality (hereinafter, main baseband processor), and processing circuitry that provides LP-WU functionality (hereinafter low-power baseband processor). In the instant description, the baseband processing circuitry 208 may include a memory 209, such as, for example, a set of RAM arrays in a Fast Fourier Transform or Inverse Fast Fourier Transform block (not shown) of the baseband processor 208. Processing circuitry 210 may include control logic to process the signals received from the receive signal path of the radio IC circuitry 206. Baseband processing circuitry 208 is also configured to also generate corresponding baseband signals for the transmit signal path of the radio IC circuitry 206, and may further include physical layer (PHY) and medium access control layer (MAC) circuitry, and may further interface with application processor 211 for generation and processing of the baseband signals and for controlling operations of the radio IC circuitry 206. Referring still to FIG. 2, according to the shown embodiment, a MAC mobility management processor 213 may include a processor having logic to provide a number of higher MAC functionalities. For example, processor 213 may instruct the waking up of the main processor, such as the Wi-Fi processor, based on the device receiving and decoding a LP-WU signal. In the alternative, or in conjunction with the MAC mobility management processor 213, some of the higher-level MAC functionalities above may be provided by application processor 211.

In some demonstrative embodiments, the front-end module circuitry 204, the radio IC circuitry 206, and baseband processor 208 may be provided on a single radio card, such as wireless radio card 202. In some other embodiments, the one or more antennas 201, the FEM circuitry 204 and the radio IC circuitry 206 may be provided on a single radio card. In some other embodiments, the radio IC circuitry 206 and the baseband processor 208 may be provided on a single chip or integrated circuit (IC), such as IC 212.

In some demonstrative embodiments, the wireless radio card 202 may include a Wi-Fi radio card and may be configured for Wi-Fi communications, although the scope of the embodiments is not limited in this respect. In some of these embodiments, the radio architecture 201 may be configured to receive and transmit OFDM or OFDMA communication signals over a multicarrier communication channel.

In some other embodiments, the radio architecture 201 may be configured to transmit and receive signals transmitted using one or more modulation techniques other than OFDM or OFDMA, such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, and On-Off Keying (OOK), although the scope of the embodiments is not limited in this respect.

In some demonstrative embodiments, the radio-architecture 200 may include other radio cards, such as a cellular radio card configured for cellular (e.g., 3GPP such as LTE, LTE-Advanced or 5G communications).

In some IEEE 802.11 embodiments, the radio architecture 201 may be configured for communication over various channel bandwidths including bandwidths having center frequencies of 900 MHz, 2.4 GHz, 5 GHz, and bandwidths of less than 5 MHz, or of about 1 MHz, 2 MHz, 2.5 MHz, 4 MHz, 5MHz, 8 MHz, 10 MHz, 16 MHz, 20 MHz, 40MHz, 80MHz (with contiguous bandwidths) or 80+80 MHz (160 MHz) (with non-contiguous bandwidths), or any combination of the above frequencies or bandwidths, or any frequencies or bandwidths between the ones expressly noted above. In some demonstrative embodiments, a 320 MHz channel bandwidth may be used. The scope of the embodiments is not limited with respect to the above center frequencies however.

Referring still to FIG. 2, in some demonstrative embodiments, STA/AP 200 may further include an input unit 218, an output unit 219, a memory unit 215. STA/AP 200 may optionally include other suitable hardware components and/or software components. In some demonstrative embodiments, some or all of the components of STA/AP 200 may be enclosed in a common housing or packaging, and may be interconnected or operably associated using one or more wired or wireless links. In other embodiments, components of STA/AP 200 may be distributed among multiple or separate devices.

In some demonstrative embodiments, application processor 211 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Application processor 211 may execute instructions, for example, of an Operating System (OS) of STA/AP 200 and/or of one or more suitable applications.

In some demonstrative embodiments, input unit 218 may include, for example, one or more input pins on a circuit board, a keyboard, a keypad, a mouse, a touch-screen, a touch-pad, a track-ball, a stylus, a microphone, or other suitable pointing device or input device. Output unit 219 may include, for example, one or more output pins on a circuit board, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory 215 may include, for example, a Random-Access Memory (RAM), a Read-Only Memory (ROM), a Dynamic RAM (DRAM), a Synchronous DRAM (SD-RAM), a flash memory, a volatile memory, a non-volatile memory, a cache memory, a buffer, a short-term memory unit, a long-term memory unit, or other suitable memory units. Storage unit 217 may include, for example, a hard disk drive, a floppy disk drive, a Compact Disk (CD) drive, a CD-ROM drive, a DVD drive, or other suitable removable or non-removable storage units. Memory unit 215 and/or storage unit 217, for example, may store data processed by STA/AP 200.

Referring still to the demonstrative embodiment of FIG. 2, a LP-WUR of a wireless radio card may include, circuitry within FEM 204, within radio IC 206 and within baseband processing circuitry 208 that provide LP-WU functionality. According to some other embodiments, the device shown in FIG. 2 may have more than one FEM or radio IC circuitry or baseband circuitry to provide the Wi-Fi plus LP-WU functionality.

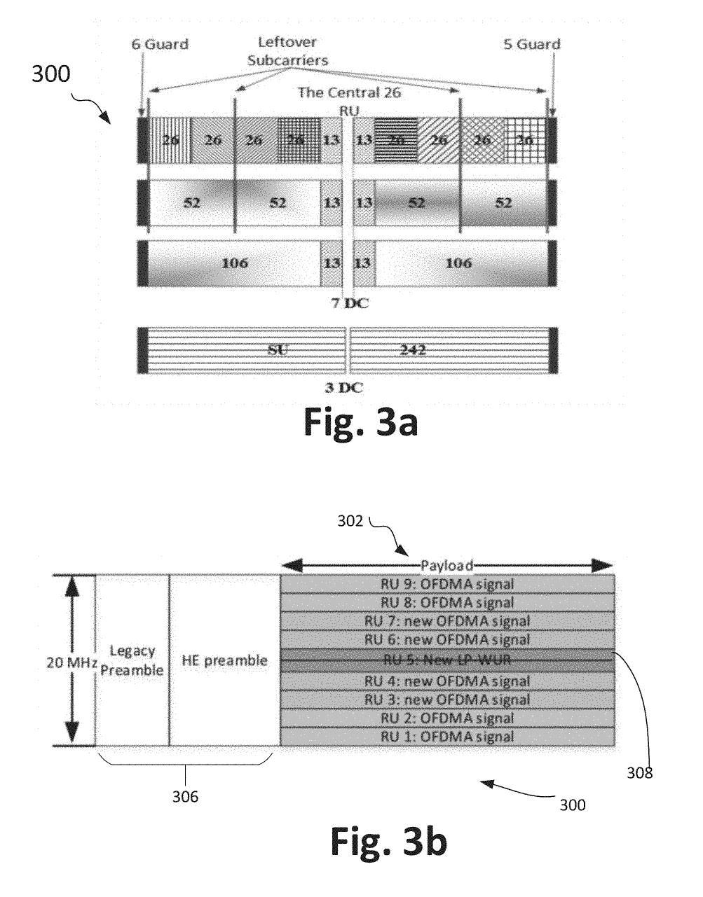

Referring next to FIG. 3a, a High Efficiency (HE) OFDMA packet 300 for a physical layer convergence procedure (PLCP) protocol data unit (PPDU) structure is shown for a 20 MHz communication as defined in 802.11ax. A HE OFDMA PPDU according to 802.11ax may carry a mixture of 26-tone, 52-tone and 106-tone RU sizes within any of the 242-tone RU boundaries as shown in FIG. 3a, and communications in 802.11ax may span 20 MHz, 40 MHz, 80 MHz, 160 MHz and a non-contiguous 80+80 MHz bandwidth. Although an exemplary RU distribution is shown for 20 MHz in FIG. 3a with 26 tone, 52 tone, 106 tone and 242 tone RUs, embodiments for example contemplate the use of any of the above bandwidths and any of the above number of tones per given bandwidth.

The shown 802.11ax top 26 RU 20 MHz band in FIG. 3a illustrates 9 RUs at fixed RU tone indices, and, additionally, 7 DC nulls, 11 guard bands with null/leftover tones. For the example of a 20 MHz HE OFDMA PPDU transmission, the 20 MHz is shown as being divided into 256 tones, with the signal being transmitted on tone −122 to −4 and 4 to 122, with 7 zeros being at the center (DC) tone. According to some demonstrative embodiments, a LP-WU signal may be used to modulate an OFDMA signal in a predetermined one of the RUs of a transmission, such as, for example, in a predetermined RU of a 26 tone RU of the 20 MHz transmission shown in FIG. 3a. OFDMA signal allocations to adjacent ones of remaining RUs (RUs where the symbols are not addressed to a LP-WU receiver) may present a same signal envelope as that of the OFDMA signal within the predetermined RU. Presenting the same envelope as between the predetermined RU (to which the OFDMA signal to be also used as a LP-WU signal at an intended LP-WU receiver) and adjacent RUs would entail ensuring that, if the predetermined RU carries an OFDMA symbol within a given time period, the adjacent RUs do as well, and if the predetermined RU is nulled within a given time period, the adjacent RUs are nulled within that time period as well. OFDMA symbols in the RUs of the OFDMA packet, may be addressed to one or more main baseband processors different from a main baseband processor to be awakened by the LP-WU packet payload.

Referring next to FIG. 3b, an OFDMA packet 300 is shown occupying a bandwidth of 20 MHz with 26 tone RUs, such as the 26 tone RUs of FIG. 3a, according to some demonstrative embodiments. The OFDMA packet 300 as shown includes a preamble 306 and a payload 302. The payload of an OFDMA packet according to some demonstrative embodiments may include three parts as shown: (1) traditional OFDMA signals (that is, OFDMA signals that are modulated in a known fashion), for example in each of RUs 1, 2, 8 and 9; (2) a “new” overlaid signal 308 in a predetermined RU, such as central RU5, which includes an LP-WUR signal overlaid onto an OFDMA signal; and (3) “new” OFDMA signals in RUs adjacent to the predetermined RU, such as for example in adjacent RUs 3, 4, 6 and 7, the new OFDMA signals being “new” in that they are generated based on the envelope of the signal transmitted in the predetermined RU, for example in RU5. The traditional OFDMA signals may be processed by destination OFDMA devices. For example, the AP in FIG. 1 could be sending the OFDMA packet 300 with OFDMA data symbols to STAs 1, 5 and 6, but with the LP-WU signal intended for STA2. In such an example, it is possible for the signals in RUs 8-9 to be addressed to STA1, RUs 1-2 to STA 5, and RUs 3-7 to STA 6. However, the OFDMA signal in RU5, which will be demodulated as OFDMA modulated data symbols by STA 6, may be overlaid with an LP-WU signal intended for the LP-WU receiver of STA 2, which will then know to demodulate the OFDMA signal in RU5 as an OOK modulated sequence of bit values equal to 1 or 0. Thus overlaid signal may be processed in different ways by two different STAs for different purposes: (1) a STA that has LP-WU receiver active and a 802.11 radio off may decode the received signal in RU5 as an OOK modulated packet and (2) a STA that has its 802.11 radio on may decode the received packet in RU5 as an OFDMA modulated signal. The new OFDMA signal in RUs 3, 4, 6 and 7 may be received by STAs to which it is addressed as a new OFDMA signal that may require that those STAs to perform envelope detection of the OFDMA signal to allow correct data demodulation, as would be recognized by one skilled in the art.

To improve the performance of a LP-WUR signal transmitted in a predetermined RU, such as RU5, in the presence of interference from the adjacent allocations, such as in RU4 and RU6 as well as alternate adjacent allocations such as RU3 and RU7, the signals transmitted in RUs 3, 4, 6 and 7 may have the same envelope as the overlaid signal allocated to RU5. Therefore, a generation method of the OFDMA signals in RUs 3, 4, 6 and 7 may be the same as that of the overlaid signal in RU5. For example, let us assume that the bit sequence of LP-WU₀ signal to be transmitted in RU5 is given by Equation 1 below x_{LP}_{_}_{WUR}=[x_{LP}_{_}_{WUR}(n)], n=1,2, . . . , N_{LP}_{_}_{WUR}, where _{LP}_{_}_{WUR}is the payload length of the wakeup signal in terms of the number of OFDMA symbols. When the n-th bit value is 1, i.e., when x_{LP}_{_}_{WUR}(n)=1, 802.11 OFDMA symbols carrying user data may be transmitted during this OFDMA symbol duration in RUs 3, 4, 5, 6 and 7. On the other hand, when x_{LP}_{_}_{WUR}(n)=0 according to some demonstrative embodiments, only pilot subcarriers may be allocated to the predetermined RU and to its adjacent RUs, and transmitted during this symbol duration therefore in RUs 3, 4, 5, 6 and 7, with the rest of subcarriers being nulled to transmit bit information 0 in OOK. As a result of the above, the new overlaid signal in RU 5 may include both the OOK modulated LP-WU signal and the OFDMA modulated user data signal in the time periods when x_{LP}_{_}_{WUR}(n)=1. In addition, adjacent RUs, which may have the same envelope as the predetermined RU, such as RUs 3, 4, 6 and 7 with the same envelope as RU5, may transmit OFDMA signals only during the time periods when x_{LP}_{_}_{WUR}(n)=1. During the time periods when x_{LP}_{_}_{WUR}(n)=0 however, there may be no data transmission, except for, in certain embodiments, a transmission of pilot tones.

The transmitted signals in adjacent RUs have a higher chance of leaking into the overlaid signal in the predetermined RU5. However, since the OFDMA signal may, according to demonstrative embodiments, be transmitted only during the time periods when x_{LP}_{_}_{WUR}(n)=1, the interference would advantageously be added positively at the OOK demodulator/baseband processor. Some demonstrative embodiments contemplate transmitting only pilot tones for each of the RUs during time periods where the signal in the predetermined RU is nulled. According to demonstrative embodiments, an intended LP-WU receiver would know how to decode the above signal by virtue of an indication of such a signal in the OFDMA packet, for example through such an indication in the HE packet preamble.

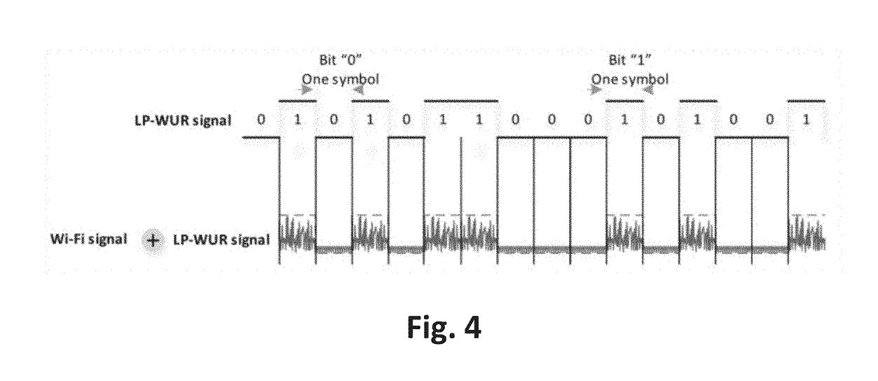

Referring next to FIG. 4, a graph is provided which illustrates a configuration of the overlaid signal showing an exemplary sequence of bit values of 1 and 0 that define a LP-WU packet according to some demonstrative embodiments. While the bottom portion of FIG. 4 shows an example of Wi-Fi signals modulated as bit values of 0's and 1's, the top portion shows the sequence of bit values for the OOK modulated LP-WU signal. According to some demonstrative embodiments, as suggested for example in FIG. 4, silence or null periods during x_{LP}_{_}_{WUR}(n)=0 may occupy only a portion of the signal bandwidth. An impact of a method according to some demonstrative embodiments on energy detection at other Wi-Fi receivers may be advantageously negligible, since a transmission of several consecutive x_{LP}_{_}_{WUR}(n)=0 is not expected to be detected as a silence interval for a random Wi-Fi device/STA in the vicinity of the transmitter/AP. Thus, the STA's clear channel assessment (CCA) may not be adversely affected. If the OOK modulation were to cover the entire bandwidth of the OFDMA packet, or, if several RUs of the OFDMA packet were nulled as guard bands, then the energy detection during consecutive x_{LP}_{_}_{WUR}(n)=0's would have disadvantageously fallen considerably below the detection threshold for STAs in the vicinity of the AP, especially at a cell edge which receives signals with low strengths routinely. Avoiding the above problem is one of the many advantages according to some demonstrative embodiments.

As used in this disclosure, when “at least one of” a given set or list of items connected with “and” is mentioned herein, what is meant is a reference to either one of the noted items, or any combination of the items. For example, as used herein, “at least one of A, B and C” means “A, or B, or C, or A and B, or A and C, or B and C, or A and B and C.”

Reference will now be made to FIGS. 1, 2, 3a, 3b, 4 and 5 in order to describe some demonstrative embodiments, although it is to be noted that embodiments are not limited to what is described below and shown with respect to FIG. 1, or 2, or 3a or 3b, or 4 or 5, or any of the other figures included herein.

According to some demonstrative embodiments, a wireless communication device, such as a baseband processor 208 within the STA 200 of FIG. 2, may comprise a memory 209 and processing circuitry 210 coupled to the memory 209. The processing circuitry 210 may include a low power baseband processor (such as the circuitry within baseband processing circuitry 208 that allows LP-WU functionality), and a main baseband processor (such as the circuitry within baseband processing circuitry 208 that allows Wi-Fi functionality). The processing circuitry may also include logic to cause the low-power baseband processor to process an orthogonal frequency division multiple access (OFDMA) signal, such as signal 308 of FIG. 3b, allocated to a predetermined resource unit (RU), such as RU5 of FIG. 3b, of an OFDMA packet, such as packet 300 of FIG. 3b, as an OOK modulated signal including a sequence of bit values of 1 and 0, the sequence representing a low-power wake up (LP-WU) packet. For example, the OFDMA signal may be modulated as shown by way of example in FIG. 4. The OFDMA packet may have a plurality of RUs, such as OFDMA packet 300 of FIG. 3b having RUs 1-9, and being addressed to one or more destination OFDMA devices. The low power baseband processor may be adapted to decode an OFDMA symbol allocated to the predetermined RU as a bit value of 1, and to decode an absence of an OFDMA symbol from the predetermined RU as a bit value of 0, as suggested for example in the bit sequence shown in FIG. 4 by way of example. The logic may further cause a wake-up of the main baseband processor based on the LP-WU packet. The waking up may be achieved for example through a MAC mobility management processor, such as MAC mobility management processor 213 of FIG. 2, through an application processor, such as application processor 211 of FIG. 2, or through software, firmware or drivers located elsewhere on STA/AP 200 of FIG. 2. The logic may further cause the main baseband processor, such as a Wi-Fi baseband processor, to process subsequent OFDMA modulated data symbols as OFDMA modulated data symbols (and not as OOK modulated symbols) after waking up.

According to some demonstrative embodiments, a tone spacing the OFDMA signals, and the LP-WU signal overlaid thereon, may be 78.125 kHz, the symbol duration may be 12.8 μs, and the OFDMA signal may have a FFT size of 256. According to some demonstrative embodiments, an OFDMA packet according to demonstrative embodiments may have a contiguous bandwidth of 20 MHz, 40 MHz, 80 MHz, 160 MHz, or 320 MHz, or a non-contiguous bandwidth of 80+80 MHz (160 MHz). As further seen in FIG. 3b, a baseband processing circuitry such as baseband processing circuitry 208, may generate a preamble for the symbol, as shown for example by preamble 502 in FIG. 5.

According to some demonstrative embodiments, a wireless communication device, such as a baseband processor 208 within the AP 200 of FIG. 2, may comprise a memory 209 and processing circuitry 210 coupled to the memory 209. The processing circuitry may include logic to generate an orthogonal frequency division multiple access (OFDMA) packet, such as packet 300 of FIG. 3b. The packet 300 may have a payload, such as payload 302, the payload including a plurality of RUs, such as RUs 1-9, and being addressed to destination OFDMA devices. The payload may further carry an OFDMA signal, such as signal 308 of FIG. 3b, allocated to a predetermined RU of the plurality of RUs, such as to the central RU5. The OFDMA signal may include therein, as shown by way of example in FIG. 4, a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices. The logic may further cause transmission of the OFDMA packet.

The OFDMA packet according to some demonstrative embodiments may be in conformance with an Institute of Electrical and Electronics Engineers (IEEE) 802.11ax wireless communication protocol, and the LP-WU packet may be in conformance with an IEEE Low-Power Wake-Up Receiver wireless communication protocol.

According to some demonstrative embodiments, a wireless communication device, such as a baseband processor 208 within the STA 200 of FIG. 2, may comprise a memory 209 and processing circuitry 210 coupled to the memory 209. The processing circuitry may include logic to process an orthogonal frequency division multiple access (OFDMA) signal within a RU of an OFDMA packet, such as the OFDMA signals in any of RUs 3-7 of packet 300 in FIG. 3b, the packet having a preamble and a payload, such as preamble 306 and payload 302. The logic further is to determine from an indication within the preamble, such as within the HE preamble of preamble 306 in FIG. 3b, that the signal is an overlaid signal, that is, an OFDMA signal that includes a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver other than the device. The baseband processor may then perform envelope detection on the OFDMA signal to determine the sequence defining the LP-WU packet, and may demodulate the data using the sequence. The logic may perform envelope detection and demodulation of the data in parallel or in series as would be recognized by one skilled in the art.

Referring next to FIG. 5, a LP-WU packet 508 according to an exemplary embodiment is shown along with the preamble portion 506. It is to be noted that this preamble portion 506 in FIG. 5 corresponds to the preamble portion 306 in FIG. 3b, and it is therefore to be understood that this preamble portion 506 has a bandwidth for the entire symbol and not only the bandwidth of the LP-WU packet or payload 508 as FIG. 5 may appear to suggest. For example, the preamble 506 may be transmitted on a channel bandwidth in compliance with 802.11ax, and the payload 512 may be transmitted on a 2.03125 MHz, 4.0625 MHz, or 8.28125 MHz channel. Preamble 506 may include a legacy short-training field (L-STF) 502, a legacy long training field (L-LTF) 504, and a legacy signal (L-SIG) field 505, and an HE preamble 507 in compliance with 802.11ax. According to other embodiments, preamble 506 may be in compliance with another communication standard is the second signal into which the LP-WU packet is to be multiplexed is in compliance with this other communication standard, such as Bluetooth. In some demonstrative embodiments, a LP-WUR may ignore the legacy preamble 506. The legacy preamble 503 would allow legacy 802.11 STAs to detect the beginning of the compound packet (that is, packet including the first signal multiplexed into the second signal) through L-STF 502, and the end of the same through information within L-SIG 505, while the HE preamble would allow HE STAs to detect among other things whether the compound packet includes HE signals. According to some demonstrative embodiments, the HE preamble may further include an indication as to whether the OFDMA packet that include the HE preamble is carrying an overlaid signal. The LP-WU payload 508 may include a Wake-Up Preamble 510, a MAC header 512, a frame body 514, and a frame check sequence field (FCS) 516 for error correction. The low modulation packet may include information in a field, such as in the MAC header 512 or in the frame body 514, regarding an identifier/address for the STA for which the LP-WU packet is destined. The other RUs that carry 802.11ax PPDUs would be addressed to radios other than the one to be awakened by virtue of the LP-WU packet 508.

In some demonstrative embodiments, the LP-WU packet 508 may be transmitted in a central portion of the channel that the preamble 506 is transmitted on. The packet 508 may use a different modulation as compared with the modulation of the preamble, such as OOK.

The wake-up preamble 510 may include a sequence of wake-up pulses, and may be generated by OOK modulation of a pattern (e.g., [1 1 0 . . . 1 0]). According to an exemplary embodiment, the MAC header 512 may be a header that includes a source address or identifier for the source generating the pulse, or a destination address or identifier for the STA to which the LP-WU packet is destined or both. In the alternative, the frame body or LP-WU payload 508 may be the body of the frame that includes one or more of the above identifiers. The identifier may be an identifier of one or more LP-WURs within STAs to which the LP-WU packet may be addressed. According to some demonstrative embodiments, one LP-WU could be addressed to multiple STAs. According to some other demonstrative embodiments, the identifier may indicate that the LP-WU packet 508 is for one or more LP-WURs with a given identifier within a number of STAs. In some demonstrative embodiments, the identifier may be termed a wake-up identifier. The FCS 515 may include information for a LP-WUR to check the integrity of the payload 508.

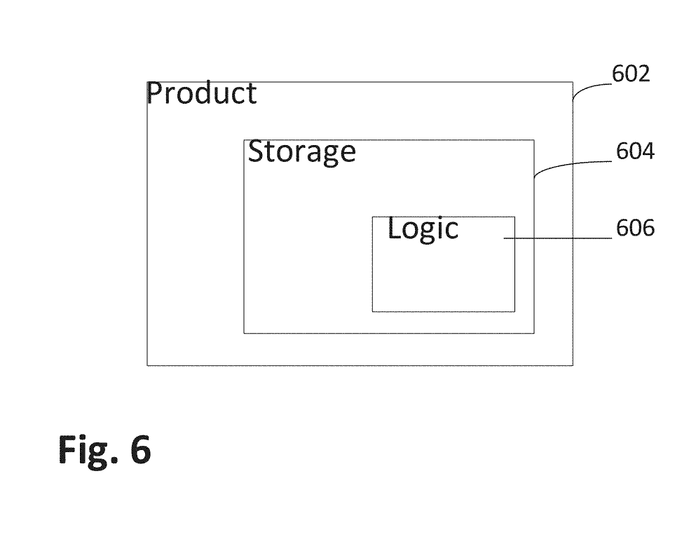

FIG. 6 illustrates a product of manufacture 600, in accordance with some demonstrative embodiments. Product 600 may include one or more tangible computer-readable non-transitory storage media 602, which may include computer-executable instructions, e.g., implemented by logic 604, operable to, when executed by at least one computer processor, enable the at least one computer processor to implement one or more operations at one or more STAs or APs, and/or to perform one or more operations described above with respect to FIGS. 1, 2, 3a, 3b, 4 and 5, and/or one or more operations described herein. The phrase “non-transitory machine-readable medium” is directed to include all computer-readable media, with the sole exception being a transitory propagating signal.

In some demonstrative embodiments, product 600 and/or storage media 602 may include one or more types of computer-readable storage media capable of storing data, including volatile memory, non-volatile memory, removable or non-removable memory, erasable or non-erasable memory, writeable or re-writeable memory, and the like. For example, storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

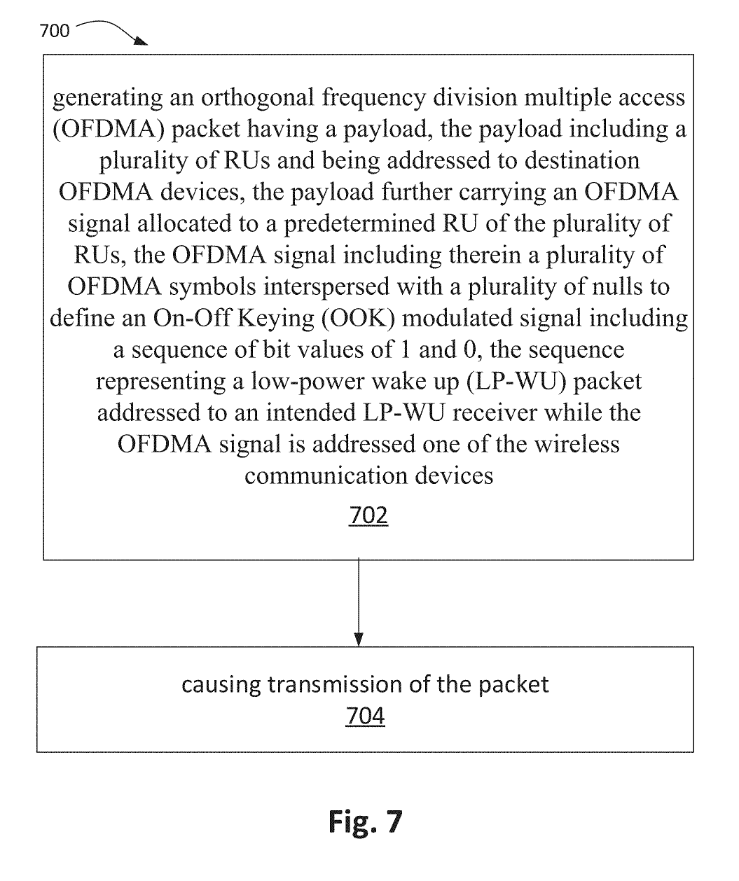

FIG. 7 illustrates a method 700 to be performed by a wireless communication device in accordance with some demonstrative embodiments. The method 700 may begin with operation 702, which includes generating an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices. At operation 704, the method includes causing transmission of the packet.

Some demonstrative embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the device 200 of FIG. 2 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

### EXAMPLES

The following examples pertain to further embodiments.

Example 1 includes a wireless communication device comprising a memory and processing circuitry coupled to the memory, the processing circuitry having a main baseband processor and a low power baseband processor, the processing circuitry further including logic to: cause the low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0; cause a wake-up of the main baseband processor based on the LP-WU packet; and cause the main baseband processor to process subsequent OFDMA modulated data symbols as OFDMA modulated data symbols after waking up.

Example 2 includes the subject matter of Example 1, and, optionally, wherein the predetermined RU includes a central RU and a plurality of non-central RUs on each side of the central RU in a frequency domain.

Example 3 includes the subject matter of Example 1, and, optionally, wherein the predetermined RU and adjacent RUs adjacent to the predetermined RU have a same signal envelope.

Example 4 includes the subject matter of any one of Examples 1-2, and optionally, wherein, during an absence of an OFDMA symbol from the predetermined RU within the sequence, the RUs of the OFDMA signal carry only pilot tones and non-pilot tones within the RUs are nulled.

Example 5 includes the subject matter of Example 3, and optionally, wherein, during an absence of an OFDMA symbol from the predetermined RU within the sequence, the adjacent RUs of the OFDMA signal carry only pilot tones and non-pilot tones within the adjacent RUs are nulled.

Example 6 includes the subject matter of any one of Examples 1-3, and optionally, wherein: a tone spacing between tones of the RUs is 78.125 kHz; a symbol duration for the symbols is 12.8 μs ; the symbols have a FFT size of 256; and a smallest RU of the OFDMA packet includes 26 tones.

Example 7 includes the subject matter of any one of Examples 1-3, and optionally, wherein the OFDMA packet has a contiguous bandwidth of 20 MHz, 40 MHz, 80 MHz, 160 MHz, or 320 MHz, or a non-contiguous bandwidth of 80+80 MHz (160 MHz).

Example 8 includes the subject matter of any one of Examples 1-3, and optionally, wherein the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 9 includes the subject matter of any one of Examples 1-3, and optionally, further comprising: a radio; and a front-end module coupled to the radio.

Example 10 includes the subject matter of Example 9, and optionally, further including one or more antennas connected to the front-end module.

Example 11 includes method to be performed by a wireless communication device, the method comprising: causing a low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0; causing a wake-up of a main baseband processor based on the LP-WU packet; and causing the main baseband processor to process subsequent OFDMA modulated data symbols as OFDMA modulated data symbols after waking up.

Example 12 includes the subject matter of 11, and optionally, wherein the predetermined RU includes a central RU and a plurality of non-central RUs on each side of the central RU in a frequency domain.

Example 13 includes the subject matter of 11, and optionally, wherein the predetermined RU and adjacent RUs adjacent to the predetermined RU have a same signal envelope.

Example 14 includes the subject matter of any one of Examples 11-12, and optionally, wherein, during an absence of an OFDMA symbol from the predetermined RU within the sequence, the RUs of the OFDMA signal carry only pilot tones and non-pilot tones within the RUs are nulled.

Example 15 includes the subject matter of 13, and optionally, wherein, during an absence of an OFDMA symbol from the predetermined RU within the sequence, the adjacent RUs of the OFDMA signal carry only pilot tones and non-pilot tones within the adjacent RUs are nulled.

Example 16 includes the subject matter of any one of Examples 11-13, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 17 includes a product comprising one or more tangible computer-readable non-transitory storage media comprising computer-executable instructions operable to, when executed by at least one computer processor, enable the at least one computer processor to implement operations at a wireless communication device, the operations comprising: causing a low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0; causing a wake-up of a main baseband processor based on the LP-WU packet; and causing the main baseband processor to process subsequent OFDMA modulated data symbols as OFDMA modulated data symbols after waking up.

Example 18 includes the subject matter of Example 17, and optionally, wherein the predetermined RU includes a central RU and a plurality of non-central RUs on each side of the central RU in a frequency domain.

Example 19 includes the subject matter of Example 17, and optionally, wherein the predetermined RU and adjacent RUs adjacent to the predetermined RU have a same signal envelope.

Example 20 includes the product of any one of claims 17-18, wherein, during an absence of an OFDMA symbol from the predetermined RU within the sequence, the RUs of the OFDMA signal carry only pilot tones and non-pilot tones within the RUs are nulled.

Example 21 includes the subject matter of Example 19, and optionally, wherein, during an absence of an OFDMA symbol from the predetermined RU within the sequence, the adjacent RUs of the OFDMA signal carry only pilot tones and non-pilot tones within the adjacent RUs are nulled.

Example 22 includes the subject matter of any one of Examples 17-19, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 23 includes a wireless communication device comprising: means for causing a low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0; means for causing a wake-up of a main baseband processor based on the LP-WU packet; and means for causing the main baseband processor to process subsequent OFDMA modulated data symbols as OFDMA modulated data symbols after waking up.

Example 24 includes the subject matter of Example 23, and optionally, wherein the predetermined RU includes a central RU and a plurality of non-central RUs on each side of the central RU in a frequency domain.

Example 25 includes the subject matter of any one of Examples 23-25, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 26 includes the subject matter of Example 23, and optionally, wherein the predetermined RU and adjacent RUs adjacent to the predetermined RU have a same signal envelope.

Example 27 includes the subject matter of any one of Examples 23-24 and optionally, wherein, during an absence of an OFDMA symbol from the predetermined RU within the sequence, the RUs of the OFDMA signal carry only pilot tones and non-pilot tones within the RUs are nulled.

Example 28 includes the subject matter of Example 25, and optionally, wherein, during an absence of an OFDMA symbol from the predetermined RU within the sequence, the adjacent RUs of the OFDMA signal carry only pilot tones and non-pilot tones within the adjacent RUs are nulled.

Example 29 includes a wireless communication device comprising a memory and processing circuitry coupled to the memory, the processing circuitry including logic to: generate an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices; and cause transmission of the OFDMA packet.

Example 30 includes the subject matter of Example 29, and optionally, wherein the predetermined RU includes a central RU and a plurality of non-central RUs on each side of the central RU in a frequency domain.

Example 31 includes the subject matter of Example 29, and optionally, wherein the predetermined RU and adjacent RUs adjacent to the predetermined RU have a same signal envelope.

Example 32 includes the subject matter of any one of Examples 29-30, and optionally, wherein, during an absence of an OFDMA symbol from the predetermined RU within the sequence, the RUs of the OFDMA signal carry only pilot tones and non-pilot tones within the RUs are nulled.

Example 33 includes the subject matter of Example 31, and optionally, wherein, during an absence of an OFDMA symbol from the predetermined RU within the sequence, the adjacent RUs of the OFDMA signal carry only pilot tones and non-pilot tones within the adjacent RUs are nulled.

Example 34 includes the subject matter of any one of Examples 29-31, and optionally, wherein the OFDMA packet further includes a preamble, the preamble including an indication of a modulation of the OFDMA signal as an OOK modulated signal representing the LP-WU packet.

Example 35 includes the subject matter of any one of Examples 29-31, and optionally, wherein: a tone spacing between tones of the RUs is 78.125 kHz; a symbol duration for the symbols is 12.8 μs; the symbols have a FFT size of 256; and a smallest RU of the OFDMA packet includes 26 tones.

Example 36 includes the subject matter of any one of Examples 29-3, and optionally, wherein the OFDMA packet has a contiguous bandwidth of 20 MHz, 40 MHz, 80 MHz, 160 MHz, or 320 MHz, or a non-contiguous bandwidth of 80+80 MHz (160 MHz).

Example 37 includes the subject matter of any one of Examples 29-31, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 38 includes the subject matter of any one of Examples 29-31, and optionally, further comprising: a radio; and a front-end module coupled to the radio.

Example 39 includes the subject matter of Example 36, and optionally, further including one or more antennas connected to the front-end module.

Example 40 includes the method to be performed at a wireless communication device, the method comprising: generating an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the destination OFDMA devices; and causing transmission of the OFDMA packet.

Example 41 includes the subject matter of 40, and optionally, wherein the predetermined RU includes a central RU and a plurality of non-central RUs on each side of the central RU in a frequency domain.

Example 42 includes the subject matter of 40, and optionally, wherein the predetermined RU and adjacent RUs adjacent to the predetermined RU have a same signal envelope.

Example 43 includes the subject matter of any one of Examples 40-41, and optionally, wherein, during an absence of an OFDMA symbol from the predetermined RU within the sequence, the RUs of the OFDMA signal carry only pilot tones and non-pilot tones within the RUs are nulled.

Example 44 includes the subject matter of any one of Examples s 42, and optionally, wherein, during an absence of an OFDMA symbol from the predetermined RU within the sequence, the adjacent RUs of the OFDMA signal carry only pilot tones and non-pilot tones within the adjacent RUs are nulled.

Example 45 includes the subject matter of any one of Examples 40-42, and optionally, wherein the OFDMA packet further includes a preamble, the preamble including an indication of a modulation of the OFDMA signal as an OOK modulated signal representing the LP-WU packet.

Example 46 includes the subject matter of any one of Examples 40-42, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 47 includes a product comprising one or more tangible computer-readable non-transitory storage media comprising computer-executable instructions operable to, when executed by at least one computer processor, enable the at least one computer processor to implement operations at a wireless communication device, the operations comprising: generating an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices; and causing transmission of the OFDMA packet.

Example 48 includes the subject matter of Example 47, and optionally, wherein the predetermined RU includes a central RU and a plurality of non-central RUs on each side of the central RU in a frequency domain.

Example 49 includes the subject matter of Example 47, and optionally, wherein the predetermined RU and adjacent RUs adjacent to the predetermined RU have a same signal envelope.

Example 50 includes the subject matter of any one of Examples 47-48, and optionally, wherein, during an absence of an OFDMA symbol from the predetermined RU within the sequence, the RUs of the OFDMA signal carry only pilot tones and non-pilot tones within the RUs are nulled.

Example 51 includes the subject matter of any one of Examples 49, and optionally, wherein, during an absence of an OFDMA symbol from the predetermined RU within the sequence, the adjacent RUs of the OFDMA signal carry only pilot tones and non-pilot tones within the adjacent RUs are nulled.

Example 52 includes the subject matter of any one of Examples 47-49, and optionally, wherein the OFDMA packet further includes a preamble, the preamble including an indication of a modulation of the OFDMA signal as an OOK modulated signal representing the LP-WU packet.

Example 53 includes the subject matter of any one of Examples 47-49, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

Example 54 includes a wireless communication device, the apparatus comprising: means for generating an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices; and means for causing transmission of the OFDMA packet.

Example 55 includes the subject matter of Example 54, and optionally, wherein the predetermined RU includes a central RU and a plurality of non-central RUs on each side of the central RU in a frequency domain.

Example 56 includes the subject matter of Example 54, and optionally, wherein the predetermined RU and adjacent RUs adjacent to the predetermined RU have a same signal envelope.

Example 57 includes the subject matter of any one of Examples 54-55 and optionally, wherein, during an absence of an OFDMA symbol from the predetermined RU within the sequence, the RUs of the OFDMA signal carry only pilot tones and non-pilot tones within the RUs are nulled.

Example 58 includes the subject matter of any one of Examples 56 and optionally, wherein, during an absence of an OFDMA symbol from the predetermined RU within the sequence, the adjacent RUs of the OFDMA signal carry only pilot tones and non-pilot tones within the adjacent RUs are nulled.

Example 59 includes the subject matter of any one of Examples 54-56 and optionally, wherein the OFDMA packet further includes a preamble, the preamble including an indication of a modulation of the OFDMA signal as an OOK modulated signal representing the LP-WU packet.

Example 60 includes the subject matter of any one of Examples 54-56, and optionally, wherein: the OFDMA packet is in conformance with an Institute of Electrical and Electronics Engineers (IEEE) 802.11ax wireless communication protocol; and the LP-WU packet is in conformance with an IEEE Low-Power Wake-Up Receiver wireless communication protocol.

What is claimed is:

1. A wireless communication device comprising a memory and processing circuitry coupled to the memory, the processing circuitry having a main baseband processor and a low power baseband processor, the processing circuitry further including logic to:
cause the low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0;
cause a wake-up of the main baseband processor based on the LP-WU packet; and
cause the main baseband processor to process subsequent OFDMA modulated data symbols as OFDMA modulated data symbols after waking up.

2. The device of claim 1, wherein the predetermined RU includes a central RU and adjacent RUs adjacent to the central RU, the adjacent RUs and the central RU having a same signal envelope.

3. The device of claim 2, wherein, during an absence of an OFDMA symbol from the central RU, the adjacent RUs carry only pilot tones and non-pilot tones of the adjacent RUs are nulled.

4. The device of claim 1, wherein:
a tone spacing between tones of the RUs is 78.125 kHz;
a symbol duration for the symbols is 12.8 μs;
the symbols have a FFT size of 256;
a smallest RU of the OFDMA packet includes 26 tones; and
the OFDMA packet has a contiguous bandwidth of 20 MHz, 40 MHz, 80 MHz, 160 MHz, or 320 MHz, or a non-contiguous bandwidth of 80+80 MHz (160 MHz).

5. The device of claim 1, further comprising:
a radio; and
a front-end module coupled to the radio.

6. The device of claim 5, further including one or more antennas connected to the front-end module.

7. The device of claim 1, wherein:
the OFDMA packet is in conformance with an Institute of Electrical and Electronics Engineers (IEEE) 802.11ax wireless communication protocol; and
the LP-WU packet is in conformance with an IEEE Low-Power Wake-Up Receiver wireless communication protocol.

8. A product comprising one or more tangible computer-readable non-transitory storage media comprising computer-executable instructions operable to, when executed by at least one computer processor, enable the at least one computer processor to implement operations at a wireless communication device, the operations comprising:
causing a low-power baseband processor to process an orthogonal frequency division multiple access (OFDMA) signal allocated to a predetermined resource unit (RU) of an OFDMA packet as an OOK modulated signal including a sequence of bit values of 1 and 0, the sequence representing a low-power wake up (LP-WU) packet, the OFDMA packet having a plurality of RUs and being addressed to one or more destination OFDMA devices, wherein the low power baseband processor is to decode an OFDMA symbol allocated to the predetermined RU as a bit value of 1, and to decode an absence of an OFDMA symbol from the predetermined RU as a bit value of 0;
causing a wake-up of a main baseband processor based on the LP-WU packet; and
causing the main baseband processor to process subsequent OFDMA modulated data symbols as OFDMA modulated data symbols after waking up.

9. The product of claim 8, wherein the predetermined RU includes a central RU and adjacent RUs adjacent to the central RU, the adjacent RUs and the central RU having a same signal envelope.

10. The product of claim 9, wherein, during an absence of an OFDMA symbol from the central RU, the adjacent RUs carry only pilot tones and non-pilot tones of the adjacent RUs are nulled.

11. The product of claim 8, wherein:
the OFDMA packet is in conformance with an Institute of Electrical and Electronics Engineers (IEEE) 802.11ax wireless communication protocol; and
the LP-WU packet is in conformance with an IEEE Low-Power Wake-Up Receiver wireless communication protocol.

12. A wireless communication device comprising a memory and processing circuitry coupled to the memory, the processing circuitry including logic to:
generate an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the other wireless communication devices; and
cause transmission of the OFDMA packet.

13. The device of claim 12, wherein the predetermined RU includes a central RU and adjacent RUs adjacent to the central RU, the adjacent RUs and central RU having a same signal envelope.

14. The device of claim 13, wherein, during an absence of an OFDMA symbol from the central RU, the adjacent RUs of the OFDMA signal carry only pilot tones and non-pilot tones of the adjacent RUs are nulled.

15. The device of claim 12, wherein the OFDMA packet further includes a preamble, the preamble including an indication of a modulation of the OFDMA signal as an OOK modulated signal representing the LP-WU packet.

16. The device of claim 12, wherein:
the OFDMA packet is in conformance with an Institute of Electrical and Electronics Engineers (IEEE) 802.11ax wireless communication protocol; and
the LP-WU packet is in conformance with an IEEE Low-Power Wake-Up Receiver wireless communication protocol.

17. The device of claim 12, further comprising:
a radio;
a front-end module coupled to the radio; and
one or more antennas connected to the front-end module.

18. A method to be performed at a wireless communication device, the method comprising:
generating an orthogonal frequency division multiple access (OFDMA) packet having a payload, the payload including a plurality of RUs and being addressed to destination OFDMA devices, the payload further carrying an OFDMA signal allocated to a predetermined RU of the plurality of RUs, the OFDMA signal including therein a plurality of OFDMA symbols interspersed with a plurality of nulls to define an On-Off Keying (OOK) modulated signal including a sequence of bit values of 1 and 0, the sequence representing a low-power wake up (LP-WU) packet addressed to an intended LP-WU receiver while the OFDMA signal is addressed one of the destination OFDMA devices; and
causing transmission of the OFDMA packet.

19. The method of claim 18, wherein the predetermined RU includes a central RU and adjacent RUs adjacent to the central RU, the adjacent RUs and the central RU having a same signal envelope.

20. The method of claim 18, wherein the OFDMA packet further includes a preamble, the preamble including an indication of a modulation of the OFDMA signal as an OOK modulated signal representing the LP-WU packet.

21. The method of claim 19, wherein, during an absence of an OFDMA symbol from the central RU, the adjacent RUs of the OFDMA signal carry only pilot tones and non-pilot tones of the adjacent RUs are nulled.

22. The method of claim 19, wherein, during an absence of an OFDMA symbol from the central RU, the adjacent RUs of the OFDMA signal carry only pilot tones and non-pilot tones of the adjacent RUs are nulled.

23. The method of claim 18, wherein the OFDMA packet further includes a preamble, the preamble including an indication of a modulation of the OFDMA signal as an OOK modulated signal representing the LP-WU packet.

24. The method of claim 18, wherein:
a tone spacing between tones of the RUs is 78.125 kHz;
a symbol duration for the symbols is 12.8 μ;
the symbols have a FFT size of 256;
a smallest RU of the OFDMA packet includes 26 tones; and
the OFDMA packet has a contiguous bandwidth of 20 MHz, 40 MHz, 80 MHz, 160 MHz, or 320 MHz, or a non-contiguous bandwidth of 80+80 MHz (160 MHz).

25. The method of claim 18, wherein:
the OFDMA packet is in conformance with an Institute of Electrical and Electronics Engineers (IEEE) 802.11ax wireless communication protocol; and
the LP-WU packet is in conformance with an IEEE Low-Power Wake-Up Receiver wireless communication protocol.
